(19) United States
(12) Patent Application Publication
(10) Pub. No.: US 2010/0017814 A1
(43) Pub. Date: Jan. 21, 2010

(54) METHODS AND SYSTEMS FOR DELIVERING PROMOTIONAL CONTENT FOR PRESENTATION IN AN INTERACTIVE MEDIA GUIDANCE APPLICATION

(75) Inventor: Kuan Hidalgo Archer, Los Angeles, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 12/177,788

(22) Filed: Jul. 22, 2008

Related U.S. Application Data
(60) Provisional application No. 61/080,723, filed on Jul. 15, 2008.

(51) Int. Cl. H04H 60/32; H04N 7/025

(52) U.S. Cl. 725/14; 725/34

(57) ABSTRACT

In some embodiments, methods for delivering promotional content for presentation in a first interactive media guidance application on a first user equipment device are provided, the methods comprising: receiving data corresponding to a plurality of user actions in a second interactive media guidance application; associating at least one of a plurality of weights with each of the plurality of user actions; based upon the plurality of user actions and the at least one of the plurality of weights associated with each user action, determining the likelihood of a user watching at least one of a certain program, a certain type of program, and a certain channel; selecting promotional content for presentation in the first interactive media guidance application based on the determination; and transmitting the promotional content selected to the first user equipment device with program content.

This application claims the benefit of U.S. Provisional Application No. 61/080,723, filed Jul. 15, 2008, the disclosure of which is hereby incorporated by reference herein in its entirety.

### BACKGROUND OF THE INVENTION

Interactive television program guides are popular mechanisms through which television viewers can view and select from ever-increasing television programming choices. In interactive television program guides, it may be desirable to include promotional content for programs described in the guides. Such promotional content may include trailers and artwork.

In some systems, however, bandwidth for transmitting such promotional content is limited. For example, the size of a trailer (which may be a video clip) can be very large compared to other data describing a corresponding program.

Accordingly, it is desirable to control the bandwidth used by promotional content being transmitted to an interactive program guide.

### SUMMARY OF THE INVENTION

Methods and systems for delivering promotional content for presentation in an interactive media guidance application are provided in accordance with various embodiments of the present invention. In some embodiments, methods for delivering promotional content for presentation in a first interactive media guidance application on a first user equipment device are provided, the methods comprising: receiving data corresponding to a plurality of user actions in a second interactive media guidance application; associating at least one of a plurality of weights with each of the plurality of user actions; based upon the plurality of user actions and the at least one of the plurality of weights associated with each user action, determining the likelihood of a user watching at least one of a certain program, a certain type of program, and a certain channel; selecting promotional content for presentation in the first interactive media guidance application based on the determination; and transmitting the promotional content selected to the first user equipment device with program content.

In some embodiments, systems for delivering promotional content for presentation in a first interactive media guidance application on a first user equipment device are provided, the systems comprising: at least one processor that: receives data corresponding to a plurality of user actions in a second interactive media guidance application; associates at least one of a plurality of weights with each of the plurality of user actions; based upon the plurality of user actions and the at least one of the plurality of weights associated with each user action, determines the likelihood of a user watching at least one of a certain program, a certain type of program, and a certain channel; selects promotional content for presentation in the first interactive media guidance application based on the determination; and causes the promotional content selected to be transmitted to the first user equipment device with program content.

In some embodiments, systems for delivering promotional content for presentation in a first interactive media guidance application on a first user equipment device are provided, the systems comprising: means for receiving data corresponding to a plurality of user actions in a second interactive media guidance application; means for associating at least one of a plurality of weights with each of the plurality of user actions; means for determining, based upon the plurality of user actions and the at least one of the plurality of weights associated with each user action, the likelihood of a user watching at least one of a certain program, a certain type of program, and a certain channel; means for selecting promotional content for presentation in the first interactive media guidance application based on the determination; and means for causing the promotional content selected to be transmitted to the first user equipment device with program content.

### BRIEF DESCRIPTION OF THE DRAWINGS

FIG. 1 illustrates an example of a grid display in an interactive media guidance application in accordance with some embodiments of the present invention.

FIG. 2 illustrates an example of a mosaic display in an interactive media guidance application in accordance with some embodiments of the present invention.

FIG. 3 illustrates an example of user equipment devices that may be used to implement an interactive media guidance application in accordance with some embodiments of the present invention.

FIG. 4 illustrates an example of a system for implementing an interactive media guidance application in accordance with some embodiments of the present invention.

FIG. 5 illustrates an example of a process for selecting promotional content in accordance with some embodiments of the present invention.

FIG. 6 illustrates an example of a system that may be used in connection with a process for selecting promotional content as illustrated in FIG. 5 in accordance with some embodiments of the present invention.

FIG. 7 illustrates an example of a user interface for selecting a basis or bases for selecting promotional content in accordance with some embodiments of the present invention.

FIG. 8 illustrates an example of a user interface for selecting user actions to be monitored in accordance with some embodiments of the present invention.

### DETAILED DESCRIPTION OF VARIOUS EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content (which may be referred to herein as “programs” or “programming”) including conventional television programming, as well as pay-per-view programs, on-demand programs (as in video-on-demand (VOD) systems), Internet content (e.g., streaming media, downloadable media, Webcasts, etc.), and other types of media or video content (any or all of which may be provided by media providers (e.g., television broadcasters, cable television providers, satellite television providers, Internet service providers, etc.) via traditional broadcast, cable, satellite, Internet, or any other suitable mechanism(s)). Guidance applications may also allow users to navigate among and locate content related to the video content including, for example, video clips, articles, advertisements, chat sessions, games, etc., any or all of which may be promotional content.

With the advent of the Internet, mobile computing, and high-speed wireless networks, users are accessing media on personal computers (PCs) and other devices on which they traditionally did not, such as hand-held computers, personal digital assistants (PDAs), mobile telephones, vehicle entertainment systems, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a Web-site), or as stand-alone applications or clients on hand-held computers, PDAs, mobile telephones, portable streaming media players, or other mobile devices. The various devices and platforms that may implement media guidance applications are described in more detail below.

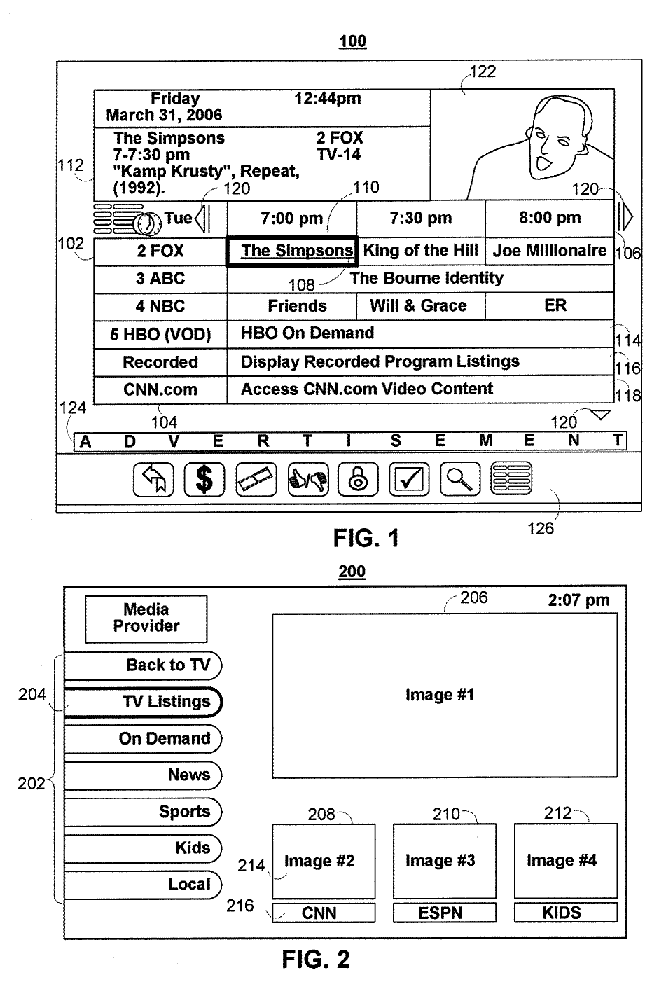

One of the functions of the media guidance application is to provide media listings and media information to users. FIGS. 1-2 show illustrative display screens that may be used to provide media guidance, and in particular media listings. The display screens shown in FIGS. 1-2 and 7-8 may be implemented on any suitable device or platform. While the displays of FIGS. 1-2 and 7-8 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or by pressing a dedicated button (e.g., a GUIDE button) on a remote control or other user input interface or device. In response to the user's indication, a media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that enables access to different types of media content in a single display. Display 100 may include grid 102 with: (1) a column of channel/media type identifiers 104, where each channel/media type identifier (which is a cell in the column) identifies a different source of programming (which may also be referred to as a “station”); and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the station for the channel, the program's rating, and other desired information. The channel the program is on may be any suitable indicator and may be used as a mechanism for a user to identify the source of programming for the program (also referred to herein as a “station”). For example, this indicator may be a number (e.g., 123), may be one or more characters (e.g., WNBC), may be a logo, or may be any other suitable indicator. The indicator for a station may or may not correspond to a broadcast channel of the station. For example, the indicator for station WNBC in New York City (which is broadcast over the air, and on many cable television providers, on channel 4) may be a value other than 4 (e.g., 123).

In addition to providing access to linear programming provided according to a schedule, a media guidance application may also provide access to non-linear programming which is not provided according to a schedule. Non-linear programming may include content from different media sources including on-demand media content (e.g., video-on-demand (VOD)), Internet content (e.g., streaming media, downloadable media, etc.), locally stored media content (e.g., video content stored on a digital video recorder (DVR), digital video/versatile disc (DVD), video cassette, compact disc (CD), etc.), or other time-insensitive media content. On-demand content may include both movies and original media content provided by a particular source of programming (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include Web events, such as a chat session or Webcast, or content available on-demand as streaming media or downloadable media through an Internet Web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed may be based on user selection or guidance application definition (e.g., a display of only recorded and broadcast listings, only on-demand and broadcast listings, etc.), and any suitable permutation may be used. As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102, and may include program content, promotional content, etc. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content, any or all of which may be promotional content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. Patent Application Publication No. 2003/0110499 A1, published Jun. 12, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting a program and/or channel as a favorite, purchasing a program, or other features. Options available from a main menu display may include search options, VOD options, parental control options, options to access various types of listing displays, options to subscribe to a premium service, options to edit a user's profile, options to access a browse overlay, or other options.

The media guidance application may be personalized based on a user's preferences. A personalized media guidance application may allow a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from Web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. Patent Application Publication No. 2005/0251827 A1, published Nov. 10, 2005, Boyer et al., U.S. Pat. No. 7,165,098, issued Jan. 16, 2007, and Ellis et al., U.S. Patent Application Publication No. 2002/0174430 A1, published Nov. 21, 2002, which are hereby incorporated by reference herein in their entireties. Collectively, the displays, features, user preferences, presentation schemes, aspects of media content listing displayed, desired recording features, parental controls, and/or desired customizations may be referred to as a “skin” to the media guidance application. In some embodiments, various options of skins may be provided to a user and/or customizable by a user.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. The listings in display 200 are not limited to simple text (e.g., the program title) and icons to describe media. Rather, in display 200 the listings may provide promotional content in the form of graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are illustrated as being of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

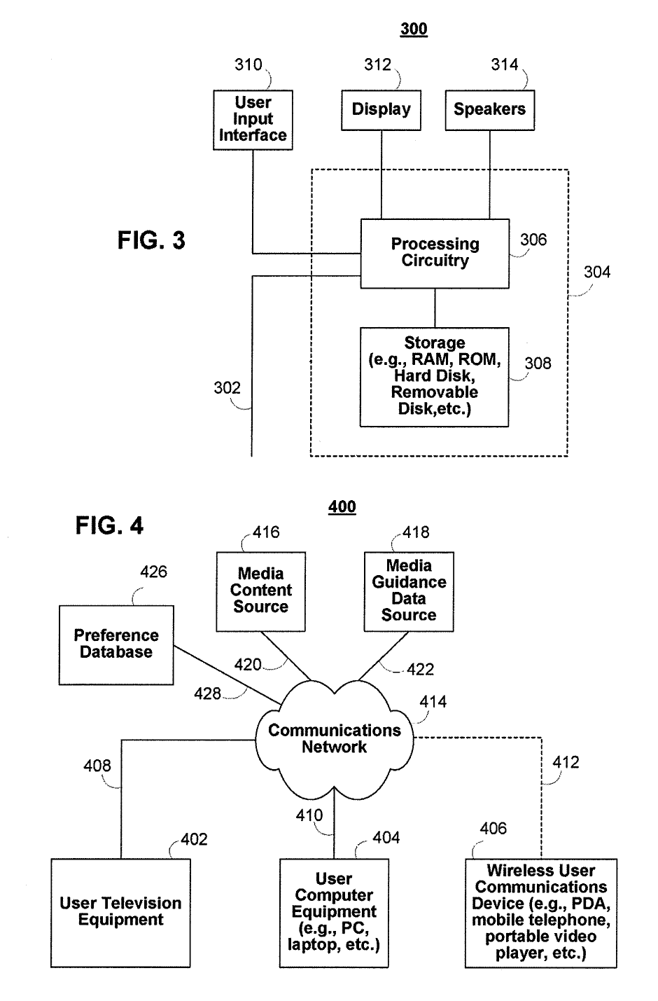

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, a wireless modem for communications with other equipment, a fiber-optic communications interface, a network interface (e.g., for an Ethernet network), and/or any other suitable interface. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Non-volatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV (now known as MSN TV) is a trademark owned by Microsoft Corp. Wireless user communications device 406 may include PDAs, a mobile telephone, a portable video player, a portable music player, a portable streaming media player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a Web site accessed by a Web browser. In another example, the guidance application may be scaled down for wireless user communications devices.

In addition to providing an interactive media guidance application, in some embodiments, some or all of user television equipment 402, user computer equipment 404, and/or wireless user communications device 406 can provide other functions. For example, these user equipment devices may provide navigation functions as part of an embedded or a portable navigation system. As a more particular example, an interactive media guidance application and a navigation system may be included in user equipment devices used on, or which are part of, an automobile, a motorcycle, a boat, a ship, an airplane, or other vehicle. As another more particular example, an interactive media guidance application and a navigation system may be included in user equipment devices which are also mobile telephones, portable entertainment devices (e.g., such as music or video players), portable email devices, etc.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to control, and/or maintain consistent media guidance application settings across, in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the Web site www.tvguide.com on their personal computer at their office, the same channel may appear as a favorite on the user's in-home devices (e.g., user television equipment and user computer equipment) as well as the user's mobile devices, if desired. As another example, a user may specify using one device (e.g., a portable device or one mounted in the user's automobile) that a program is to be recorded on another of the user's devices (e.g., the user's home device). Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 may be coupled to communications network 414 via communications paths 408, 410, and 412, respectively. Communications network 414 may be one or more networks including the Internet, a mobile phone network, mobile device (e.g., Blackberry) network, cable network, public switched telephone network, a satellite network (e.g., a satellite television network, or other satellite communications network) or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416, media guidance data source 418, and preference database 426 coupled to communications network 414 via communication paths 420, 422, and 428, respectively. Paths 420, 422, and 428 may include any of the communication paths described above in connection with paths 408, 410, and 412. Communications with each of the media content source 416, media guidance data source 418, and preference database 428 may be exchanged over one or more communications paths, but are shown as a single path in FIG. 4 to avoid overcomplicating the drawing. In addition, there may be more than one of each of media content source 416, media guidance data source 418, and preference database 426, but only one of each is shown in FIG. 4 to avoid overcomplicating the drawing. (The different types of each of these mechanisms are discussed below.) If desired, two or more of media content source 416, media guidance data source 418, and preference database 426 may be integrated as one source device. Although communications between sources 416 and 418 and database 426 with user equipment devices 402, 404, and 406 are shown as through communications network 414, in some embodiments, sources 416 and 418 and database 426 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, telephone company television providers, or other providers of media content, which may control the distribution equipment, and the distribution functions of, media content source 416. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. Patent Application Publication No. 2003/0149988 A1, published Aug. 7, 2003, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), promotional content, on-demand information, and any other type of guidance data that is helpful for a user to navigate among and locate desired media selections. Broadcast channels and logo data may be used to indicate an over-the-air channel number, a call sign (or call letters), a logo, etc. associated with a broadcaster or station. In some embodiments, media guidance data source 418 may host a Web-based interactive media guidance application (such as www.tvguide.com) that can be accessed using user equipment devices.

Preference database 426 may be a database for storing, for one or more guidance applications, any suitable data relating to skins, displays and features which create a personalized “experience,” presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and/or any other desired customizations. Preference database 426 may be implemented in any suitable hardware and/or software, such as a server on the Internet (for example), and may be implemented using any suitable data storage technique.

Media guidance data may be provided to the user equipment devices using any suitable approach. In some embodiments, the guidance application may be a stand-alone interactive television program guide that receives media guidance data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, after a user-specified period of time, after a system-specified period of time, in response to a request from user equipment, etc.). In some approaches, guidance data from media guidance data source 418 may be provided to users' equipment using a client-server approach. For example, a guidance application client residing on a user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following seven approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Application Publication No. 2005/0251827 A1, published Nov. 10, 2005. Different types of user equipment devices in a home network may also communicate with each other to transmit media content. For example, a user may transmit media content from user computer equipment to a portable video player or a portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access a media guidance application on a Web site via a personal computer at their office, on a mobile device such as a PDA or Web-enabled mobile telephone, on a vehicle-based system that is part of or coupled to a navigation system, etc. The user may set various settings (e.g., recordings, reminders, or other settings) on the guidance application to control the user's in-home equipment. The guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Patent Application Publication No. 2005/0028208 A1, published Feb. 3, 2005, which is hereby incorporated by reference herein in its entirety.

In a third approach, users of user equipment devices inside and outside a home can use their media guidance application to communicate directly with media content source 416 to access media content. Specifically, within a home, users of user television equipment 402 and user computer equipment 404 may access the media guidance application to navigate among and locate desirable media content. Users may also access the media guidance application outside of the home using wireless user communications devices 406 to navigate among and locate desirable media content.

In a fourth approach, a wireless user communications device 406 (such as a portable streaming media player) may be used to receive programming via a wireless signal. This device may also include an interactive media guidance application for controlling, via two-way communication with a media content server 416 and a media guidance data source 418, the programming presented on the device. The guidance application may present program guide data and promotional content relating to programming available on the device using any suitable interface, for example such as illustrated in, and described in connection with, FIGS. 1-2. As a more particular example, a user using such a device may use an interactive media guidance application as illustrated in FIG. 2 to view promotional content such as video clips, still images, etc. relating to programs available to be streamed to the device. The user may then select one of the programs, thereby causing the selected program to be streamed to the user's device 406 from content server 416.

In a fifth approach, a wireless user communications device 406 (such as a portable media player) may also be used to receive programming via a wireless signal. An Internet-based interactive media guidance application for controlling the programming available on the device may be accessible via a separate device, such as an Internet-connected computer containing a Web browser. More particularly, for example, the Internet-based guidance application may be accessed by using user computer equipment 404 to connect to a Web address (e.g., www.tvguide.com). Once accessed, the Internet-based guidance application may present program guide data and promotional content relating to programming available on the device using any suitable interface, for example such as illustrated in, and described in connection with, FIGS. 1-2. The user may then use this guidance application to select content to be presented on the wireless user communications device. The selected program content, related program guide data and related promotional content may then be transmitted together to the wireless user communications device via any suitable mechanism and protocol. This program guide data and promotional content may then be used to present a separate interactive media guidance application on the wireless device. To view a program on the device, a user may then select one of the programs described in the wireless-device-based guidance application. The program may then be presented from storage on the wireless device or via streaming content from media content server.

In a sixth approach, user television equipment 406 (such as a set-top box and television (which may be integrated)) may be used to receive programming via any suitable television signal (e.g., such as a broadcast, cable, or satellite signal). This equipment may also include an interactive media guidance application for controlling, via two-way communication with a media content server 416 and a media guidance data source 418, the programming presented on the equipment. The guidance application may present program guide data and promotional content relating to programming available on the equipment using any suitable interface, for example such as illustrated in, and described in connection with, FIGS. 1-2. As a more particular example, a user using such equipment may use an interactive media guidance application as illustrated in FIG. 2 to view promotional content such as video clips, still images, etc. relating to programs available to be streamed to the equipment. The user may then select one of the programs, thereby causing the selected program to be presented on the equipment (e.g., by tuning to a corresponding channel, by initiating a video-on-demand program delivery, by playing a recorded program, etc.).

In a seventh approach, user television equipment 402 may be used to receive programming via any suitable delivery mechanism (e.g., via broadcast, cable, or satellite delivery). An Internet-based interactive media guidance application for controlling the programming available on the equipment may be accessible via a separate device, such as an Internet-connected computer containing a Web browser. More particularly, for example, the Internet-based guidance application may be accessed by using user computer equipment 404 to connect to a Web address (e.g., www.tvguide.com). Once accessed, the Internet-based guidance application may present program guide data and promotional content relating to programming available on the user television equipment using any suitable interface, for example such as illustrated in, and described in connection with, FIGS. 1-2. The user may then use this guidance application to select content to be presented on the equipment. The program guide data and promotional content related to the selected content may then be transmitted together with the same or other program content to the user television equipment via any suitable mechanism and protocol. This program guide data and promotional content may then be used to present a separate interactive media guidance application on the user television equipment. To view a program on the equipment, a user may then select one of the programs described in the user-television-equipment-based guidance application. The program may then be presented on the user television equipment (e.g., by tuning to a corresponding channel, by initiating a video-on-demand program delivery, by playing a recorded program, etc.).

As described above, in some embodiments, such as that illustrated in, and described in connection with, FIG. 2, promotional content (such as trailers (e.g., in the form of video clips) and program artwork (e.g., in the form of thumbnail images)) for programs may be presented in an interactive media guidance application. This promotional content may consume large amounts of data compared to the program guide data corresponding to the same programs. For example, a short video clip may consume much more data than text that may be used to provide program guide data. This increased consumption may limit the amount of promotional content that can be effectively transmitted to user equipment.

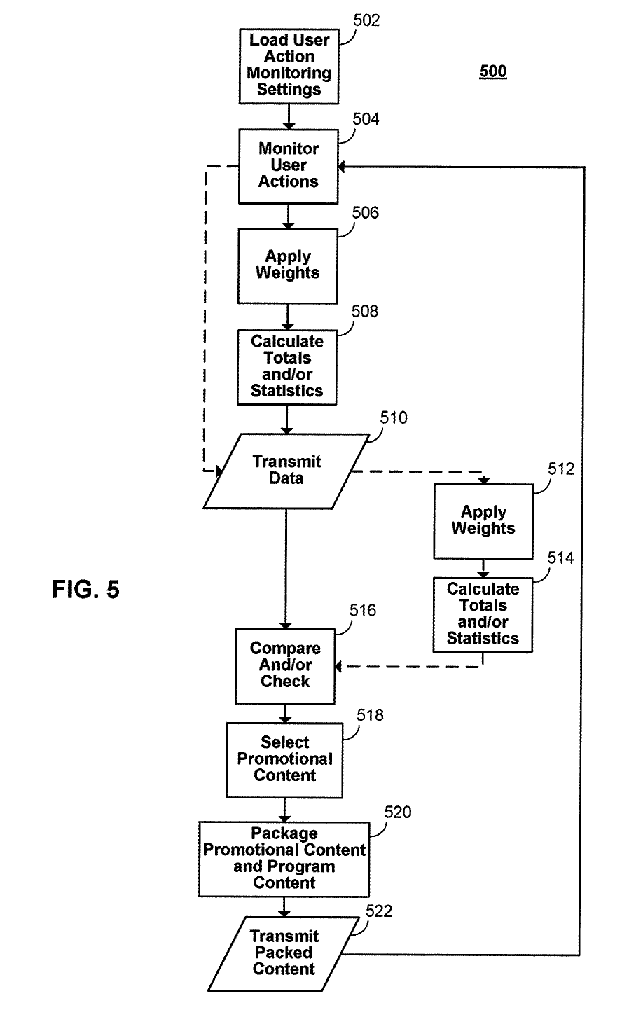

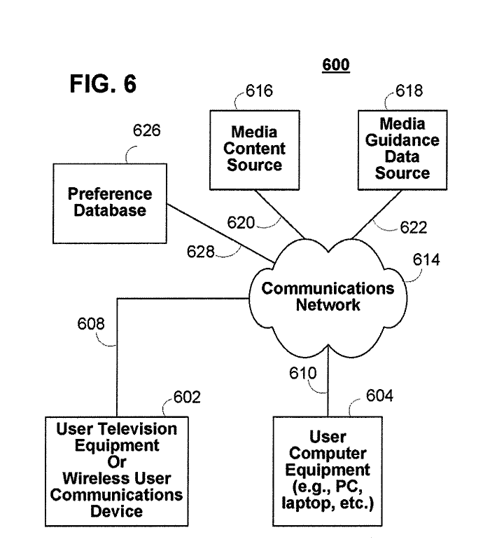

In order to control the amount of data used when transmitting promotional content to an interactive media guidance application on user equipment, in some embodiments, subsets of the available promotional content may be selected for transmission as described below in connection with FIGS. 5-6 for example. These subsets may be selected based on what programs a user is most-likely to watch, based on what types of programs a user is most-likely to watch, based on what channels a user is most-likely to watch, based on the times at which a user is most-likely to watch programs, based on programs corresponding to a user's favorites list, based on a programs recommended for a user (such recommendations may be made in any suitable fashion as known in the art), based on any other suitable criteria or criterion, or based on any suitable combination of criteria. For the sake of illustration in connection with FIGS. 5 and 6, it will briefly be assumed that the subsets will be selected based on what programs a user is most-likely to watch. The programs that a user is most-likely to watch may be determined in some embodiments by monitoring user activity when watching programming or using an interactive media guidance application, such as shown in process 500 of FIG. 5. FIG. 6 represents a block diagram of hardware that may be used in some embodiments, and the components shown in FIG. 6 may be implemented as described above in connection with FIG. 4. For the sake of illustration, assume a user is interacting with an interactive media guidance application on user computer equipment 604 and is or will be receiving program content and promotional content on user television equipment or wireless user communication device 602.

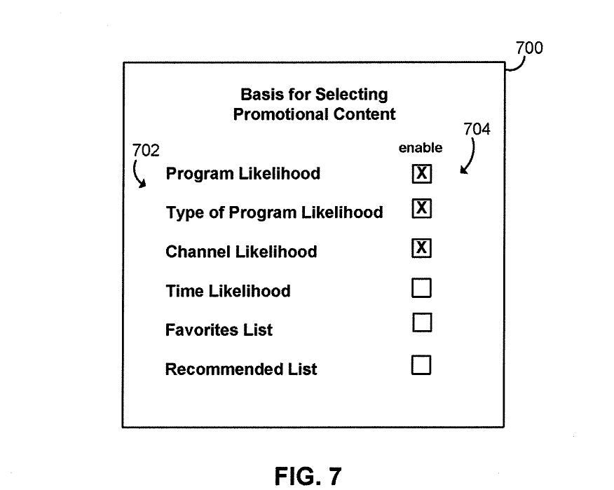

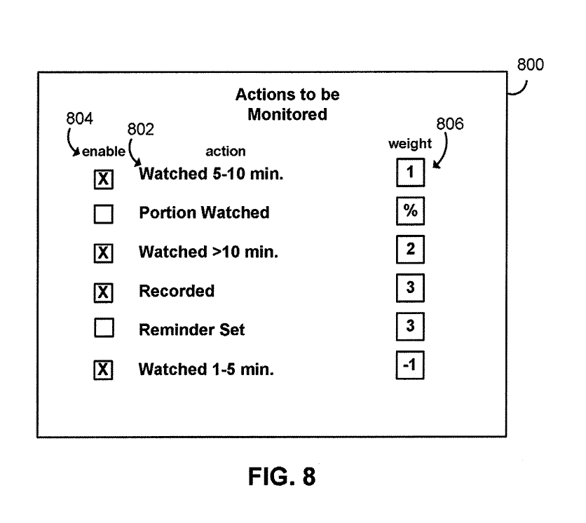

Turning to FIG. 5, process 500 for controlling promotional content may begin by loading action monitoring settings at step 502. These settings may be loaded from database 626. The settings may have been previously set as described below in connection with FIGS. 7 and 8, set by a system operator, set automatically by any suitable algorithm, or set in any other suitable manner, in various embodiments. Next, the user's actions in the guide of equipment 602 may be monitored at step 504. The following user activities may be monitored in some embodiments, for example: what programs a user watches, what types of programs a user watches, what channels a user watches, what program a user has specifically indicated he/she likes, what programs a user has specifically indicated that he/she does not like, the times at which a user watches programming, etc. Monitoring these activities may be accomplished in any suitable manner. For example, a user's actions may be monitored by determining which programs the user records, which programs the user sets reminders for, which programs the user selects from a program guide for immediate viewing, which programs the user stays tuned to for some minimum period of time after a channel change (for example, when manually entering a channel number or when using a channel up/down button when “surfing channels”), which programs for which the user presses a “likes” button (e.g., a “thumbs-up” button) on a remote control, which programs for which the user presses a “dislikes” button (e.g., a “thumbs-down” button) on a remote control, which programs correspond to Web pages or advertisements viewed and/or selected by a user (e.g., where the correspondence is via relating to a common program, relating to a common actor, relating to a common product, etc.), etc.

Certain actions of a user may be more likely to indicate that a user will watch a program in the future. For example, a user recording all episodes of a program may indicate that a user is particularly interested in the program, whereas a user watching a program for a brief period of time may only reflect a small interest in the program. Thus, in some embodiments, a user's actions with respect to a program may be weighted when determining what programs a user is most-likely to watch.

This weighting may be performed locally at the device at which a user is interacting, such as equipment 602, at step 506, or at a remote device, such as source 618, at step 512, in different embodiments. Accordingly, FIG. 5 shows one path via steps 504, 506, 508, 510 in which the weights are applied locally, and 516, and another path via steps 504, 510, 512, 514, and 516 in which the weights are applied remotely.

Any suitable levels of weights may be applied to actions. For example, in some embodiments, discrete levels, such as a high weight and a low weight, may be applied to actions, and any suitable number of discrete levels (such as two levels for a high weighting and a low weighting) may be used. As a more particular example, a high weight may have a numerical value of 3 and a low weight may have a numerical value of 1, although any suitable values may be used. In some embodiments, non-discrete weights, such as a percentage of a program watched (e.g., 25%, 47.235%, etc.), may additionally or alternatively be used.

Certain actions of a user may be more likely to indicate that a user will not watch a program in the future. For example, a user may press a “dislikes” button on a remote control when watching a program to indicate that the user does not like a program. As another example, a user changing channels past a program when watching programming (e.g., taking no action with respect to that program) may indicate that a user does not like a program. Thus, some actions may be negatively weighted (e.g., by having a negative value such as −3) to indicate that a user is not likely to watch a program in the future. As with other weights, negative weights may have discrete levels or non-discrete levels, may have any suitable number of levels, and may have any suitable values.

The weighted actions for each program may then be totaled at step 508 (e.g., when performed by equipment 602) or 514 (e.g., when performed by source 618). For example, in some embodiments, the actions that are monitored and their corresponding weights may be: (1) recording a program (weight of 3); (2) watching a program for more than 10 minutes (weight of 2); (3) watching a program for between five and 10 minutes (weight of 1); and (4) watching a program for between one and five minutes (weight of −1). Using these actions and weights in an example, ten programs numbered “Program 1” through “Program 10” may have the corresponding actions, weights, and totals shown in the table below:

| Program | Action(s) | Weight(s) | Total Weight |
|---|---|---|---|
| Program 1 | (2) | 2 | 8 |
| | (1) | 3 | |
| | (1) | 3 | |
| Program 2 | (3) | 1 | 1 |
| Program 3 | (3) | 1 | 0 |
| | (4) | −1 | |
| Program 4 | (1) | 3 | 3 |
| Program 5 | (2) | 2 | 2 |
| Program 6 | (3) | 1 | 1 |
| Program 7 | (4) | −1 | −1 |
| Program 8 | None | 0 | 0 |
| Program 9 | None | 0 | 0 |
| Program 10 | None | 0 | 0 |

Although the weights for actions are shown as being totaled for comparison, any other suitable statistics may be additionally or alternatively used for comparison. For example, the frequencies of actions may be calculated, the mean weight values may be calculated, etc.

Data regarding user actions may be transmitted from equipment 602 to a remote location, such as source 618, at step 510. The data transmitted may include any suitable information, such as the actions, corresponding program names, corresponding program times, corresponding program channels, weights, weight totals, other statistics, any other suitable data, or any suitable combination of the same.

Next, at step 516, the totals (or other statistics) may be compared to identify the programs that a user is most-likely to watch. In observing the “Total Weight” column, it can be seen that each total weight is the sum of the weights in the “Weight(s)” column for each program. By comparing these total weights, it can be seen that Program 1 is the most-likely program to be watched, Program 4 is the next-most-likely program to be watched after Program 1, and Program 5 is the next-most-likely program to be watched after Program 4.

In some embodiments, the occurrence of an action for a program may indicate that promotional content related to the program is to be included (or not included) in a subset irrespective of other actions that may occur for the program. In such cases, alternatively to, or in addition to, totaling weights as described above, at step 516 the weights and/or actions may be checked to determine if they indicate that such an action for a program has occurred, and, if so, such programs may be flagged accordingly.

Next, based on this comparison and/or checking, promotional content may be selected to be included in a subset of the promotional materials available to be transmitted to user equipment at step 518. Any suitable relationship may be used to relate promotional content to the programs most-likely to be watched. For example, for each of the highest-ranking programs, promotional content may be selected that is for the same program, that is on the same channel as (or a neighboring channel of) the program, that is on at the same time as (or in a time window around) the program, any other suitable relationship, or any suitable combination of relationships.

The selection of promotional content may be limited based on any suitable criteria or criterion. For example, the selection may be limited based on the total size of the selected promotional content, based on the number of pieces of promotional content, based on the number of related programs (or types of programs, channels, times, etc.) on which the selection is based, etc. This limit may vary over time based on any suitable criteria or criterion, such as network load, etc.

In addition to selecting promotional content to be included in the subsets based on the comparison and/or checking, promotional content may additionally or alternatively be selected based on programs corresponding to a user's favorites list, based on programs recommended for a user (such recommendations may be made in any suitable fashion as known in the art), any other suitable criteria or criterion, or any suitable combination of the same.

In some embodiments, as mentioned above, the selected promotional content may be transmitted to the user equipment along with program content. For example, the promotional content may be transmitted on a television channel sideband, in the vertical blanking interval of a television channel, using an in-band digital signal, using an out-of-band digital signal, etc. In such cases, the promotional content and the program content may be packaged at step 520.

The selected promotional content may then be transmitted to equipment 604 at step 522.

As mentioned above, rather than selecting promotional content based on the programs a user is most-likely to watch, promotional content may additionally or alternatively be selected based on what types of programs a user is most-likely to watch, based on what channels a user is most-likely to watch, based on the times at which a user is most-likely to watch programs, based on any other suitable criteria or criterion, or based on any suitable combination of criteria.

A comparison of the types of programs that a user is most-likely to watch may be implemented as shown in the table below, for example. As can be seen, dramas are most-likely to be watched, comedies are next-most-likely to be watched after dramas, and sports programs are next-most-likely to be watched after comedies.

| Type of | | | | Total |
|---|---|---|---|---|
| Program | Program | Action(s) | Weight(s) | Weight |
| Drama | Program 1 | (2) | 2 | 8 |
| | | (1) | 3 | |
| | | (1) | 3 | |
| Sports | Program 2 | (3) | 1 | 1 |
| Comedy | Program 3 | (3) | 1 | 5 |
| | | (4) | −1 | |
| | Program 4 | (1) | 3 | |
| | Program 5 | (2) | 2 | |
| Cartoon | Program 6 | (3) | 1 | 0 |
| | Program 7 | (4) | −1 | |
| Documentary | Program 8 | None | 0 | 0 |
| | Program 9 | None | 0 | |
| | Program 10 | None | 0 | |

A comparison of the channels that a user is most-likely to watch may be implemented as shown in the table below, for example. This comparison may be based upon the monitoring of program-related activity or by monitoring activity with respect to channels, such as monitoring user selections of channels, monitoring what channels a user watches, monitoring what channels a user records, monitoring what channels a user sets reminders for, monitoring any other activity, or monitoring any combination of the same. As can be seen, channel 2 is the channel most-likely to be watched, channel 5 is the channel next-most-likely to be watched after channel 2, and channels 41 and 48 are the channels next-most-likely to be watched after channel 5.

| | | | | Total |
|---|---|---|---|---|
| Channel | Program | Action(s) | Weight(s) | Weight |
| 2 | Program 1 | (2) | 2 | 9 |
| | | (1) | 3 | |
| | | (1) | 3 | |
| | Program 2 | (3) | 1 | |
| | Program 3 | (3) | 1 | |
| | | (4) | −1 | |
| 5 | Program 4 | (1) | 3 | 6 |
| | Program 5 | (2) | 2 | |
| | Program 6 | (3) | 1 | |
| 11 | Program 7 | (4) | −1 | −1 |
| 41 | Program 8 | None | 0 | 0 |
| 48 | Program 9 | None | 0 | 0 |
| | Program 10 | None | 0 | |

A comparison of the times at which a user is most-likely to watch programs may be implemented as shown in the table below, for example. As can be seen, “M-F, 7-8 pm” is the most-likely time for the user to be watching programs, and “M-Su, 12-1 pm” is the next-most-likely time for the user to be watching programs.

| | | | | Total |
|---|---|---|---|---|
| Time | Program | Action(s) | Weight(s) | Weight |
| M-F, 7-8 | Program 1 | (2) | 2 | 9 |
| pm | | (1) | 3 | |
| | | (1) | 3 | |
| | Program 6 | (3) | 1 | |
| M-Su, | Program 3 | (3) | 1 | 3 |
| 12-1 pm | | (4) | −1 | |
| | Program 4 | (1) | 3 | |
| M, 3-4 pm | Program 5 | (2) | 2 | 2 |
| Th, 9-10 | Program 2 | (3) | 1 | 0 |
| pm | Program 7 | (4) | −1 | |
| M-F, 6-7 | Program 9 | None | 0 | 0 |
| pm | Program 8 | None | 0 | |
| Tu, 6 pm | Program 10 | None | 0 | 0 |

Turning to FIG. 7, an example of a user interface that may be used to configure the basis (or bases) on which promotional content will be selected is illustrated. As shown, the user interface may list a variety of different bases 702 on which promotional content may be selected. These bases may include the likelihood a program is going to be watched, the likelihood a type of program is going to be watched, the likelihood a channel is going to be watched, the likelihood programming will be watched at a given time, the contents of a favorites list, the contents of a recommended list, any other suitable basis or bases, or any suitable combination of bases. A user may enable a basis for inclusion in the selection process by selecting a corresponding enable box 704.

FIG. 8 illustrates an example of a user interface that may be used to select the user actions that are monitored in some embodiments. As shown, the user interface may list various actions 802. These actions may include that a program, channel, or type of program was watched for 5-10 minutes (or any other suitable period of time), that a portion of a program, channel, or type of program was watched, that a program, channel, or type of program was watched for more than 10 minutes (or any other suitable period of time), that a program, channel, or type of program was recorded, that a reminder was set for a program, channel, or type of program, that a program, channel, or type of program was watched for 1-5 minutes (or any other suitable period of time), any other suitable action or actions, or any suitable combination of actions. A user may select an action to be monitored by selecting a corresponding enable box 804. The weight for an action may also be selected by entering a value in weight box 806. As illustrated, these weights may include specific values (such as 1, 2, 3, −1, etc.) or may include symbols representative of relative values (for example, a % symbol may indicate that a percentage of the portion of a program, channel or type of program watched is to be used as a weight value).

It will be appreciated that while the discussion of media content has focused on video content, the principles of media guidance can be applied to other types of media content, such as music, images, etc.

Thus, it is seen that methods and systems for delivering promotional content for presentation in an interactive media guidance application are provided. One skilled in the art will appreciate that the invention can be practiced by other than the described embodiments, which are presented for purposes of illustration and not of limitation, that various features of the described embodiments can be interchanged and used in any suitable combination, and that the present invention is limited only by the claims which follow.

What is claimed is:

1. A method for delivering promotional content for presentation in a first interactive media guidance application on a first user equipment device, comprising:
receiving data corresponding to a plurality of user actions in a second interactive media guidance application;
associating at least one of a plurality of weights with each of the plurality of user actions;
based upon the plurality of user actions and the at least one of the plurality of weights associated with each user action, determining the likelihood of a user watching at least one of a certain program, a certain type of program, and a certain channel;
selecting promotional content for presentation in the first interactive media guidance application based on the determination; and
transmitting the promotional content selected to the first user equipment device with program content.

2. The method of claim 1, wherein the data specifies at least one of user actions taken, the time at which user actions are taken, and programs associated with the user actions taken.

3. The method of claim 1, wherein the plurality of user actions include at least one of selecting a program, watching a program, configuring to record a program, and configuring a reminder for a program.

4. The method of claim 1, wherein the plurality of user actions include at least one of selecting a channel, watching a channel, configuring to record a channel, and configuring a reminder for a channel.

5. The method of claim 1, wherein the second interactive media guidance application is presented as a Web page.

6. The method of claim 1, wherein the promotional content includes images and/or video clips.

7. The method of claim 1, wherein the promotional content selected corresponds to programs presented within a window of time around the presentation time of a program corresponding to a user action.

8. The method of claim 1, wherein the promotional content selected corresponds to programs presented within a window of channels around the channel of a program corresponding to a user action.

9. The method of claim 1, wherein the promotional content and the program content are transmitted in an analog format.

10. The method of claim 1, wherein the promotional content and the program content are transmitted in a digital format.

11. The method of claim 1, wherein the promotion content and the program content are transmitted in the same signal.

12. The method of claim 1, wherein the first interactive media guidance application is an interactive program guide.

13. The method of claim 1, wherein the second interactive media guidance application is an interactive program guide.

14. A system for delivering promotional content for presentation in a first interactive media guidance application on a first user equipment device, comprising:
at least one processor that:
receives data corresponding to a plurality of user actions in a second interactive media guidance application;
associates at least one of a plurality of weights with each of the plurality of user actions;
based upon the plurality of user actions and the at least one of the plurality of weights associated with each user action, determines the likelihood of a user watching at least one of a certain program, a certain type of program, and a certain channel;
selects promotional content for presentation in the first interactive media guidance application based on the determination; and
causes the promotional content selected to be transmitted to the first user equipment device with program content.

15. The system of claim 14, wherein the data specifies at least one of user actions taken, the time at which user actions are taken, and programs associated with the user actions taken.

16. The system of claim 14, wherein the plurality of user actions include at least one of selecting a program, watching a program, configuring to record a program, and configuring a reminder for a program.

17. The system of claim 14, wherein the plurality of user actions include at least one of selecting a channel, watching a channel, configuring to record a channel, and configuring a reminder for a channel.

18. The system of claim 14, wherein the second interactive media guidance application is presented as a Web page.

19. The system of claim 14, wherein the promotional content includes images and/or video clips.

20. The system of claim 14, wherein the promotional content selected corresponds to programs presented within a window of time around the presentation time of a program corresponding to a user action.

21. The system of claim 14, wherein the promotional content selected corresponds to programs presented within a window of channels around the channel of a program corresponding to a user action.

22. The system of claim 14, wherein the promotional content and the program content are transmitted in an analog format.

23. The system of claim 14, wherein the promotional content and the program content are transmitted in a digital format.

24. The system of claim 14, wherein the promotion content and the program content are transmitted in the same signal.

25. The system of claim 14, wherein the first interactive media guidance application is an interactive program guide.

26. The system of claim 14, wherein the second interactive media guidance application is an interactive program guide.

27. A system for delivering promotional content for presentation in a first interactive media guidance application on a first user equipment device, comprising:
means for receiving data corresponding to a plurality of user actions in a second interactive media guidance application;
means for associating at least one of a plurality of weights with each of the plurality of user actions;
means for determining, based upon the plurality of user actions and the at least one of the plurality of weights associated with each user action, the likelihood of a user watching at least one of a certain program, a certain type of program, and a certain channel;
means for selecting promotional content for presentation in the first interactive media guidance application based on the determination; and
means for causing the promotional content selected to be transmitted to the first user equipment device with program content.

28. The system of claim 27, wherein the data specifies at least one of user actions taken, the time at which user actions are taken, and programs associated with the user actions taken.

29. The system of claim 27, wherein the plurality of user actions include at least one of selecting a program, watching a program, configuring to record a program, and configuring a reminder for a program.

30. The system of claim 27, wherein the plurality of user actions include at least one of selecting a channel, watching a channel, configuring to record a channel, and configuring a reminder for a channel.

31. The system of claim 27, wherein the second interactive media guidance application is presented as a Web page.

32. The system of claim 27, wherein the promotional content includes images and/or video clips.

33. The system of claim 27, wherein the promotional content selected corresponds to programs presented within a window of time around the presentation time of a program corresponding to a user action.

34. The system of claim 27, wherein the promotional content selected corresponds to programs presented within a window of channels around the channel of a program corresponding to a user action.

35. The system of claim 27, wherein the promotional content and the program content are transmitted in an analog format.

36. The system of claim 27, wherein the promotional content and the program content are transmitted in a digital format.

37. The system of claim 27, wherein the promotion content and the program content are transmitted in the same signal.

38. The system of claim 27, wherein the first interactive media guidance application is an interactive program guide.

39. The system of claim 27, wherein the second interactive media guidance application is an interactive program guide.
